(19) United States
(12) Patent Application Publication
(10) Pub. No.: US 2005/0180266 A1
(43) Pub. Date: Aug. 18, 2005

(54) Radio timepiece

(76) Inventor: Kenji Hanai, Tokyo (JP)

Correspondence Address: DENNISON, SCHULTZ, DOUGHERTY & MACDONALD, 1727 KING STREET, SUITE 105, ALEXANDRIA, VA, 22314, US

(21) Appl. No.: 10/508,533

(22) PCT Filed: Mar. 25, 2003
(86) PCT No.: PCT/JP03/03584

(30) Foreign Application Priority Data
Mar. 26, 2002 (JP) 2002-85172
May 13, 2002 (JP) 2002136889
May 17, 2002 (JP) 2002-142516

(51) Int. Cl. G04C 11/02

(52) U.S. Cl. 368/47

(57) ABSTRACT

A radio controlled watch comprises a case made of a nonconductive material, having a middle (30), back (31) and a shield (32), and an antenna (38) provided in the case, and a part of the case is covered by an exterior member (47) made of conductive material.

### TECHNICAL FIELD

The present invention relates to a radio controlled watch which receives a radio wave including time information, and corrects the time of the watch in accordance with the information.

### BACKGROUND ART

There has already been known an electronic watch which receives waves such as a standard wave. More particularly, a radio controlled watch which receives the standard wave (carrier) including time information and extracts the time information from the radio wave so as to obtain an accurate time is known. The frequency of the radio wave including the time information varies from country to country, and for instance in Japan, the standard wave of 40 kHz is transmitted under the supervision of Ministry of Posts and Telecommunications.

FIG. 1 schematically shows functions of an example of such a radio controlled watch.

The radio controlled watch comprises an antenna 1, radio controlled watch receiver 2, CPU 3 and a display driver 4. Although not shown, the watch further includes hour and minute hands or a display such as a liquid crystal display.

The antenna receives radio waves including time information. The radio controlled watch receiver then amplifies and detects the received radio wave and extracts the time information from the radio wave which is then outputted. The CPU generates the present time data based on the time information from the receiver. The display driver displays the present time on the display based on the present time data from the CPU.

An input device 5 may be provided for applying the CPU operation information such as resetting.

The time information (time code) included in the radio wave is a 60 second cycle pulse signal. The time information includes a pulse having a width of either one of 200, 500 or 800 (msec) per second. The time information can thus be obtained in 60 seconds by combining these pulses. The CPU 3 reads the pulse width of the pulse per second of the received pulse signal so as to obtain the time information (present time). The CPU corrects the time shown on the display through the display driver 4 based on the obtained time information.

Thus, by correcting the displayed time at a predetermined interval based on the received time information, the radio controlled watch always shows the accurate time.

There has already been provided a radio controlled watch where the antenna, radio controlled watch receiver, CPU, display driver, and the display are housed in a case. The case is mainly made of a nonconductive material such as a synthetic resin and ceramics so that the antenna may receive the radio wave.

Namely, when the antenna is housed inside a case made of conductive material such as metal, a magnetic field of the antenna generates an electromotive force in the metal case, thereby inducing an electric current in the case. As a result, the magnetic field is disturbed by the electric current so that the reception ability of the antenna is so reduced as to be unable to receive the standard wave.

However, when a case of synthetic resin is used in order to avoid radio disturbances, not only resistances of the case against scratches and chemicals are decreased, but also classiness and handsome appearance which are necessary for watches used as personal adornments are also deteriorated.

Accordingly, there has been proposed a radio controlled watch wherein a metal case is employed.

FIG. 2 shows an example of the construction of the radio controlled watch having a case, a part of which is metal.

A case 10 of the watch schematically comprises a middle 11, back 12 and a shield 13. A movement 14 is disposed in the middle, which is connected to a band (not shown), by a known means. A dial 15 and hands 16, which are display means for indicating time, are also disposed by a known means. A bar antenna 17, which is a magnetic long wave antenna, is positioned under the movement and above the back. The bar antenna comprises a magnetic core 18 made of ferrite and a coil 20 wound around the magnetic core, and is secured to the upper surface of a holding member made of synthetic resin.

The movement 14 has the aforementioned radio controlled watch receiver, CPU and the display driver and is electrically conductive with the bar antenna 17 through a conductor 21. Thus, the CPU in the movement operates a gear mechanism (not shown) of the display driver in accordance with the standard wave received by the bar antenna so as to constantly correct the position of the hands 16 of the display.

The upper and lower direction referred herein is based on the vertical direction shown in FIG. 2.

The middle 11 is made of not hollow but solid conductive metal such as solid stainless steel. The shield 13 made of glass, which is a nonconductive material, is fixed on the top of the middle by a known means such as adhesive. The dial 15 is made of nonconductive material such as synthetic resin and ceramics. The back 12 comprises an annular frame 22 of stainless steel fixed to the middle 11 and a glass 23 fixed in the frame.

Although the nonconductive material can be recognized on the upper and lower surfaces of the case, the watch is thus advantageous in that the case thereof is constructed of metal side portions so that the classiness and the handsome appearance of the personal adornment are maintained.

However, since the watch shown in FIG. 2 employs a metal body as the case, the disadvantage of disposing the antenna adjacent the metal member cannot be avoided. Hence, compared to an instance where the case is entirely composed of nonconductive material, the bar antenna of the watch has almost 40% less reception ability. Accordingly, in a region where it is difficult to receive the standard waves, far from the transmitting station for example, the watch often cannot receive the standard waves.

In addition, when the space between the inner wall of the metal middle and the antenna is enlarged so as to prevent disorder in the reception ability of the bar antenna, there arises a problem that the case becomes extremely large, disproportionate for wearing on a wrist.

In order to resolve the problems, there has been proposed a construction where a middle is composed of nonconductive material and external members made of conductive material such as metal are disposed on upper and lower portions of the middle so that the reception ability of the bar antenna is improved.

However, if the upper and lower external portions are conducted to each other, an annular electric current is generated, thereby substantially deteriorating the reception ability of the antenna.

Taking into account of these technical problems, the first object of the present invention is to provide a radio controlled watch device or a signal receiving device where a radio wave including predetermined information such as time information can be favorably received, even though a conductive material such as metal is recognized on the outside.

The second object is to provide a radio controlled watch device or a signal receiving device where a conductive material such as metal is recognized on the outside, and which is reduced in size.

### DISCLOSURE OF THE INVENTION

The radio controlled watch according to claim 1 of the present invention comprises a case made of a nonconductive material and containing an antenna and a watch movement, and an exterior member made of conductive material attached on an outer portion of the case.

In accordance with the construction, the case for containing the antenna is nonconductive while the exterior member covering at least a part of the outer surface of the case is made of conductive material such as metal. Accordingly, the distance between the antenna and the conductive member is increased than in a watch with a conductive case so that radio disturbance is less liable to occur. Hence a radio controlled watch, an antenna of which is capable of good radio reception, is provided.

Moreover, since the distance between the antenna and the conductive material is increased without enlarging the case, the size of the case can be decreased compared to the conventional case.

In addition, due to the conductive metal exterior member, the radio controlled watch is accorded a metallic look. This enables the case to be recognized as being made of a solid metal, thereby maintaining classiness and beautiful appearance although a nonconductive case of synthetic resin is used.

The exterior member referred here is not a coating such as paint or plated film, but an individual member separated from the case.

Moreover, it is preferable to employ a metal, more particularly, non-magnetic metal and low magnetic metal as the conductive material of the exterior member so as not to deteriorate the reception ability of the antenna. For example, non-magnetic material such as gold, silver, copper, brass, and aluminum may be used as the metal for the exterior member. Alternatively, an austenitic stainless steel which has a low magnetism among stainless steels may be used. Furthermore, the metal may be titanium or titanium alloy.

As the nonconductive material for the case, synthetic resin, rubber, and ceramics may be used. For example, PC (polycarbonate), ABS (acrylonitrile-butadiene-styrene) resin may be used.

Although each member is secured to one another by screws in the embodiments, the radio disturbance can be further prevented when secured by adhesives.

The radio controlled watch of claim 2 is characterized in that the case has a large thickness in an axial direction of the watch compared with a thickness of the exterior member.

In accordance with the construction, since the nonconductive case having a thickness larger than that of the exterior member is provided between the conductive exterior member and the antenna, the distance between the conductive exterior member and the antenna is increased without fail. Hence a radio controlled watch, the antenna of which having a further better radio reception can be provided.

The exterior member is, for example, formed of a metal plate covering the case.

In accordance with claim 5, the exterior member comprises a plurality of members.

In accordance with claim 6, the exterior member covers an upper surface and a periphery of a middle of the case.

Thus, since the upper surface and the periphery of the case are covered by the exterior member, the radio controlled watch has an extremely metallic look.

In accordance with claim 7, it is preferable that the exterior member is disposed in a plane other than a horizontal plane including an axis of the core.

Accordingly, it is possible to prevent a deterioration of reception ability of the antenna caused by an electric current induced in the conductive exterior member.

In accordance with claim 8, it is preferable that the exterior member is disposed at a location other than on an extension line of an axis of the core.

In accordance with claim 9, the case comprises a plurality of parts at least two of which are secured to each other by a screw and the screw is disposed at a location other than on an extension line of an axis of the core.

Thus radio disturbance of the antenna due to screws is prevented even if the screws are made of a conductive material such as metal.

Furthermore, the radio controlled watch according to claim 10, the exterior member covers an upper surface of the middle.

In accordance with the construction, the upper surface of the case, which is most likely to be noticed by the wearer, has an appearance of metal. The periphery and the underside of the case need not be covered by the exterior member. Thus, the antenna can be kept away from the exterior member while giving the radio controlled watch a metallic look, thereby providing a radio controlled watch capable of good radio reception.

In accordance with claim 12, in the case the exterior member covers the upper surface of the middle of the case, the distance between the conductive exterior member and the antenna may be increased when the antenna is disposed in a lower portion of the middle.

The object can be achieved when the exterior member has an escape opening on an extension line of an axis of the core in accordance with claim 13.

In accordance with claim 14, band connecting legs for connecting bands for putting on the watch on a body of a wearer are formed on the exterior member.

Hence, an external force exerted from bands is borne by the exterior member employing rigid material such as metal.

In accordance with claim 15, it is preferable that the inner periphery of the escape opening does not construct a closed figure. The reason is that, if the opening constitutes a closed figure, an electric current induced about the opening forms a current ring, which substantially interferes with the reception by the antenna. If a cut out portion communicated with the escape opening from the edge of the exterior member is provided, the inner periphery of the escape opening is opened, thereby preventing the current ring from being generated.

Moreover, in accordance with claim 16, two opposite openings are formed on the extension line of the axis.

In addition, in accordance with claim 17, an ornament layer covers at least an exposed portion on an outer surface of the case uncovered by the exterior member. The ornament layer further enhances the appearance of the radio controlled watch. It is preferable that the ornament layer serves as a protection film for providing resistance against scratches and chemicals.

Furthermore, in accordance with claim 18, when the ornament layer is a metallic layer assuming a metallic appearance, since the exposed surface not covered by the exterior member also assumes a metallic appearance, the radio controlled watch is recognized as made entirely of metal material. Thus, a radio controlled watch having classiness and a beautiful appearance is realized.

The ornament layer may partially cover only the exposed surface of the case. However, the entire outer surface of the case may be covered by the ornament layer before the exterior members are mounted. Accordingly, the ornament layer can be easily formed on the case at a low cost.

In accordance with claim 19, the ornament layer may be formed on the case by such means as coating, wet plating and dry plating.

When the ornament layer is formed by coating, first of all, a primer layer including a polyurethane lacquer is applied. A colored acrylic lacquer is then applied on the primer layer so that a color layer determining the tone of the ornament layer is formed. Lastly, a transparent or translucent and further, hard lacquer is applied on the color layer to form a protection layer which is preferable in preventing the color layer to peel off, thereby improving resistance to wear.

Any desired tone such as stainless steel tone or gold tone may be determined as the color layer by selecting the tone of the applied lacquer. When a metallic pigment, for example, is included in the lacquer forming the color layer, the ornament layer having a metallic look is provided. As the metallic pigment, aluminum powder in the form of phosphorous flake, mica flake particles covered with metal oxides such as titanium oxide and iron oxide, graphite particles, and glass flake particles the surface of which is covered with metal may be employed for example.

In order to form the ornament layer by wet plating, firstly, oil, stains, and blemishes are removed from the surface of an injection molded case of synthetic resin with alkali solution so as to be cleaned. The surface is then roughened by etching so that the surface becomes hydrophilic for easily becoming wet, and further becomes activated by polarization. The surface is thereafter cleaned and a catalyst metal is adsorbed on the surface by catalyst treatment. The surface is again cleaned and the catalyst metal is precipitated by accelerator treatment so that the surface is activated, and the surface is further cleaned. Thus coating is easily formed on the surface.

Thereafter, a nickel coating, for example, is applied on the catalyst metal precipitated on the surface by electroless plating. A copper coating is then formed on the nickel coating by electrolytic plating, thereby providing a smooth surface as well as a shock proof property. Thus, a ground coat layer is formed on the surface of the case.

Thereafter, by forming for example, a palladium coating layer on the ground coat layer by electrolytic plating, a silver colored ornament layer having a tone close to that of stainless steel covers the outer surface of the case.

Alternatively, when a gold coating layer, or an alloy coating layer such as of gold-nickel alloy, is formed on the ground coat layer by electrolytic plating, a gold colored ornament layer covers the outer surface of the case.

However, since the ornament layer thus formed by wet plating constitutes a conductive layer, particularly in instances where the case is an annular frame such as bezel and middle in a watchcase, annular electric current is likely to be induced in the conductive layer. As a result, the annular electric current causes interfering magnetic field, which disturbs the reception of the antenna. Therefore, it is preferable that the ornament layer formed by wet plating is not a ring. Accordingly, a slit is preferably formed in a part of the ornament layer. The ornament layer which covers the annular frame such as bezel and middle is cut by the slit and hence no longer forms a ring but forms a C-shape so that the annular electric current is not generated in the ornament layer. In order to form such a slit, a portion where the slit is desired is masked before the ornament layer is formed by wet plating. A masking ink which is resistible to acid and alkali and removable by electric stripping, for example, is used. In a masking treatment for forming the mask, the masking ink may be manually applied with a brush. Hence the ornament layer is not formed on the masked portion so that the masked portion forms the slit. Instead, the mask is removed to expose the outer surface of the case so that the exposed portion of the outer surface where the ornament layer is not formed becomes the slit.

In order to form the ornament layer by dry plating, such as by sputtering, a stainless steel having low magnetism, such as austenitic stainless steel SUS304, is used as a target and a stainless steel coating film is formed on the outer surface of the case as the ornament layer. Thus the ornament layer having a stainless steel color tone is formed on the case.

Alternatively, a gold coating film or a gold alloy coating film may be formed on the outer surface of the case. Although gold-iron alloy or gold-titanium alloy may be used as the gold alloy coating film, in order not to decrease the reception ability of the antenna, gold-titanium alloy having a low magnetism is preferable.

Sputtering, arc plating, and ion plating may be employed as the dry plating.

Since the ornament layer thus formed by the dry plating is a thin film where metal forms a pillar structure, the ornament layer is advantageous in that the annular electric current which causes interfering magnetic field is less liable to be generated. The aforementioned slit may further be formed on the ornament layer.

The ornament layer of the case is thus formed as coating, wet plating layer or dry plating layer. At least two of these coating, wet plating layer and dry plating layer may be combined.

The ornament layer may further be formed on the exterior members mounted on the case by coating, wet plating or dry plating.

For example, when the exterior members are stainless steel, a gold coating film or a gold alloy coating film having gold color may be formed by dry plating such as ion plating and sputtering. In such a case, although gold-iron alloy or gold-titanium alloy may be used as the gold alloy coating film, in order not to decrease the reception ability of the antenna, gold-titanium alloy having a low magnetism is preferable.

For example, an exterior member made of brass, which has a low magnetism, is used, and a stainless steel having low magnetism, such as austenitic stainless steel SUS304, is used as a target so that the ornament layer is formed on the exterior member. Thus, a stainless steel coating film as an ornament layer having a color tone of stainless steel is formed on the outer surface of the brass exterior member.

When ornament layers are formed on the case and the exterior members by wet plating or dry plating, it is preferable that the metal included in the ornament layers is preferably a non-magnetic material so as not to reduce the reception ability of the antenna. Such a metal is at least a metal chosen from gold, silver, copper, aluminum, magnesium, zinc and alloys thereof.

When the ornament layer is formed on each of the case and the external members, by rendering the color tone of one ornament layer different from that of another, the radio controlled watch is accorded various appearances. For example, a radio controlled watch having a stainless steel color case and gold color external members may be provided.

Further, in the radio controlled watch of the present invention according to claim 20, a plurality of exterior members cover an upper surface, periphery and a lower surface of the case.

Thus, not only the upper surface and the periphery, but also the underside of the case is provided with a metallic look.

Further, in the radio controlled watch of the present invention according to claim 21, the exterior member has an upper exterior member disposed on an upper surface of the case and a lower exterior member disposed on a lower portion of the case. Thus, not only the upper surface, but also the underside of the case is covered with the exterior member.

According to claim 22 of the present invention, the escape opening is a projection opening which is formed at a projection plane formed by projection light rays in a direction perpendicular to the axis of the core of the antenna so that favorable reception by the antenna is maintained.

According to claim 23 of the present invention, in order to maintain favorable reception of the antenna, it is preferable that the projection opening has an area larger than an area of a projection of the antenna.

According to claim 24 of the present invention, it is necessary that the projection opening oppose end portions of antenna. Thus, the area of the case covered by conductive metal is increased so that the radio controlled watch has sufficient metallic look.

In such a case, according to claim 25 of the present invention, in order to maintain favorable reception of the antenna, it is preferable that the projection opening has an area larger than an are of a projection of exposed end portion exposed from the coil.

Further, in the radio controlled watch of the present invention according to claim 26, there is provided an inserting portion formed in an antenna receiving portion and inserted in the escape opening.

Accordingly, the exterior portion having the opening can be securely mounted on the case without rattling, and further, the exterior member can be accurately positioned on the case.

In such a case, according to claim 27 of the present invention, it is preferable that an outer end surface of the inserting portion is substantially flush with the exterior member having the opening.

Thus not only the appearance of the radio controlled watch is improved, but also edge of the opening is prevented from harming the skin of the wearer so that the safety is ensured.

Further, according to claim 31, if the projection opening is formed in a lower exterior member, the projection opening cannot be easily recognized so that the appearance of the radio controlled watch is not deteriorated.

Further, according to claim 32, if the projection opening has an area larger than an area of a projection of the antenna on an upper exterior member, and is formed in a lower exterior member opposite each ends of the antenna, favorable reception of the antenna is maintained without fail. The large opening formed on the upper exterior member may form a time display through which a nonconductive dial can be seen, so that the appearance of the radio controlled watch is not deteriorated.

Further, in the radio controlled watch of the present invention according to claim 33, the exterior member is inserted in a recess formed in the case.

Moreover, in the radio controlled watch of the present invention according to claim 34, the exterior member engages a ridge projecting from the case.

Thus, not only is the exterior member securely mounted on the case, but also accurately positioned on the case.

According to claim 35 of the present invention, a radio controlled watch comprises a case made of a nonconductive material and containing an antenna and a watch movement, a plurality of conductive exterior members attached on the outer portion of the case, and insulating means for insulating at least two of the exterior members which generates annular conduction when in contact with each other.

In accordance with such a construction, the case containing the antenna is nonconductive and the exterior member covering the case is, for example, metal and hence conductive. As a result, the distance between the antenna and the conductive member is increased, thereby decreasing the radio disturbance of the antenna than when the case itself is conductive. Thus, there is provided a radio controlled watch where the antenna can favorably receive radio waves.

Since the distance between the antenna and the conductive material is increased without enlarging the case, the case can be rendered smaller than in conventional instances.

In addition, the conductive exterior member of such material as metal renders it possible to apply the radio controlled watch a metallic look. Thus, the case is recognized as being made of solid metal, thereby maintaining classiness and beautiful appearance while employing a nonconductive case of synthetic resin.

The exterior member referred here is not a coating such as paint and plated film, but an individual member separate from the case.

More particularly, since an insulating means for electrically insulating at least two of the plurality of exterior members us provided, it is possible to prevent the deterioration of the reception ability of the antenna due to the annular electric current induced by the exterior members.

Further, in the radio controlled watch of the present invention according to claim 36, it is preferable that the plurality of exterior members are disposed to surround the antenna.

Thus, since a large area of the outer surface of the case is covered by the exterior member, the radio controlled watch further assumes a metallic look.

In such a case, in accordance with claim 37, in order to maintain the favorable reception of the antenna, it is preferable that the insulating means insulate at least two of the exterior members so as to prevent an annular conduction surrounding the antenna.

In accordance with claim 38, if the antenna is a bar antenna comprising a core and a coil wound around the core, in order to maintain the favorable reception of the antenna, it is preferable that the insulating means is provided to insulate at least two of the exterior members so that the exterior members do not generate an annular conduction about an axis of the core.

Furthermore, in the radio controlled watch of the present invention according to claim 39, at least one opening is formed in at least one of the exterior members so that the antenna may receive radio transmission.

In accordance with claim 40, the opening in the exterior member is formed by cutting out an outer edge of the exterior member.

In accordance with claim 41, if the antenna is a bar antenna comprising a core and a coil wound around the core, in order to maintain the favorable reception of the antenna, the opening is an axial opening formed along an axis of the core.

The insulating means in the radio controlled watch of the present invention in accordance with claim 43, the insulating means is means for separating at least two of the exterior members. Thus, the exterior members are not in contact with each other so as to be electrically insulated.

In such a case, in accordance with claim 44, the insulating means is a means for mounting at least two of the exterior members in the case with a space between the exterior members.

Alternatively, in accordance with claim 45, the insulating means includes a nonconductive insulating portion disposed between at least two of the exterior members.

In accordance with claim 46, if the insulating portion is an insulating member independent from the case, and disposed between at least two of the exterior members. Accordingly, the insulating member is securely mounted between the exterior members, and the exterior members are insulated from each other without fail.

Alternatively, according to claim 47, the insulating portion includes an insulating projection formed on the case and disposed between at least two of the exterior members. Therefore, the exterior members are insulated from each other without fail, and moreover, since the case and the insulating portion are integrated, the assembling of the radio controlled watch is facilitated.

According to claim 48, the insulating portion is disposed at a position opposite a band connected to the radio controlled watch so that insulating portion is concealed by the band, and hence the appearance of the radio controlled watch is not deteriorated.

According to claim 49, the insulating portion is disposed between a pair of band connecting legs formed on the exterior member for putting on the watch on a body of a wearer so that the insulating portion is concealed by the legs and therefore not easily recognized.

According to claim 50, the insulating portion is disposed under an outwardly extending projection so that the insulating portion is concealed by the projection and therefore not easily recognized.

Further, in the radio controlled watch of the present invention according to claim 51, in order to apply the radio controlled watch with a metallic look, an exposed area of an outer surface of the case is preferably smaller than an area of an outer surface of the exterior member.

Further, in the radio controlled watch of the present invention according to claim 52, a plurality of exterior members cover an upper surface, periphery, and an underside of the case. Hence there is provided a radio controlled watch where not only the upper surface and the periphery of the case but also the underside of the case is accorded a metallic look.

Further, in the radio controlled watch of the present invention according to claim 53, the exterior member has an upper exterior member disposed on the upper surface of the case and a lower exterior member disposed on the underside of the case. Hence not only the upper surface of the case but also the underside of the case is easily covered by the exterior members.

In such a case, it is preferable that a peripheral portion for covering the periphery of the case is provided in at least one of the upper and lower exterior members according to claim 54.

### BRIEF DESCRIPTION OF DRAWINGS

FIG. 1 is a block diagram showing functions of a radio controlled watch;

FIG. 2 is a sectional view showing a radio controlled watch, a part of a case of which is made of metal;

FIG. 3 is an exploded perspective view of a first embodiment of the present invention;

FIG. 4 is a sectional view of the watch taken along twelve to six o'clock axis;

FIG. 5 is a sectional view taken along three to nine o'clock axis;

FIG. 6 is an exploded perspective view of a watch according to a second embodiment;

FIG. 7 is a perspective view showing a second exterior member;

FIG. 8 is a sectional view showing the watch along twelve to six o'clock axis;

FIG. 9 is a sectional view showing the watch along three to nine o'clock axis;

FIG. 10 is a side view;

FIG. 11 is a side view of an example of the watch;

FIG. 12 is a sectional plan view taken along the axis of a crown;

FIG. 13 is a perspective view showing a part of a third embodiment;

FIG. 14 is a perspective view showing a part of the third embodiment;

FIG. 15 is an exploded perspective view of a fourth embodiment where the present invention is applied to a watch as seen from above;

FIG. 16 is an exploded perspective view as seen from below;

FIG. 17 is a perspective view as seen from above;

FIG. 18 is a perspective view as seen from below;

FIG. 19 is a sectional view of the watch taken along twelve to six o'clock axis;

FIG. 20 is a sectional view taken along three to nine o'clock axis;

FIG. 21 is a side view of the long side of the watch;

FIG. 22 is a side view of the short side of the watch;

FIG. 23 is a plan view;

FIG. 24 is a sectional side view taken along an axis penetrating an antenna;

FIG. 25 is a sectional plan view taken along the axis penetrating the antenna;

FIG. 26 is an end side view of a core of the antenna;

FIG. 27 is a perspective view of a fifth embodiment of the present invention;

FIG. 28 is a perspective view showing an upper portion of a case;

FIG. 29 is a perspective view showing a lower portion of the case;

FIG. 30 is a perspective view showing a lower portion of an assembled watch;

FIG. 31 is a sectional plan view; and

FIG. 32 is a plan view as seen from below.

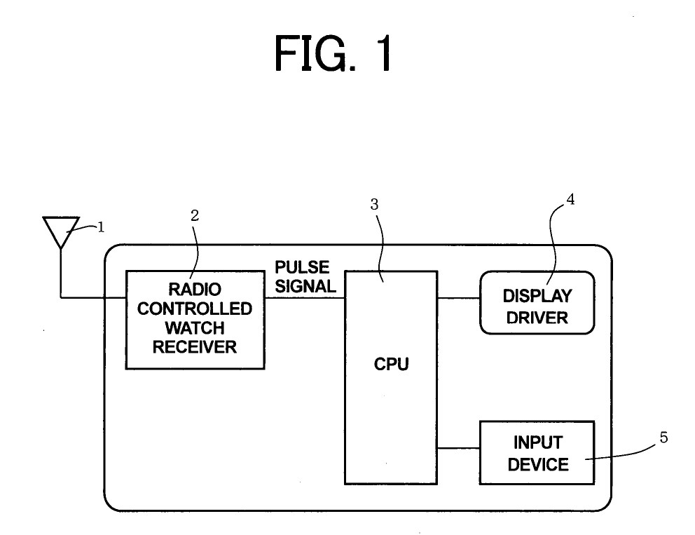

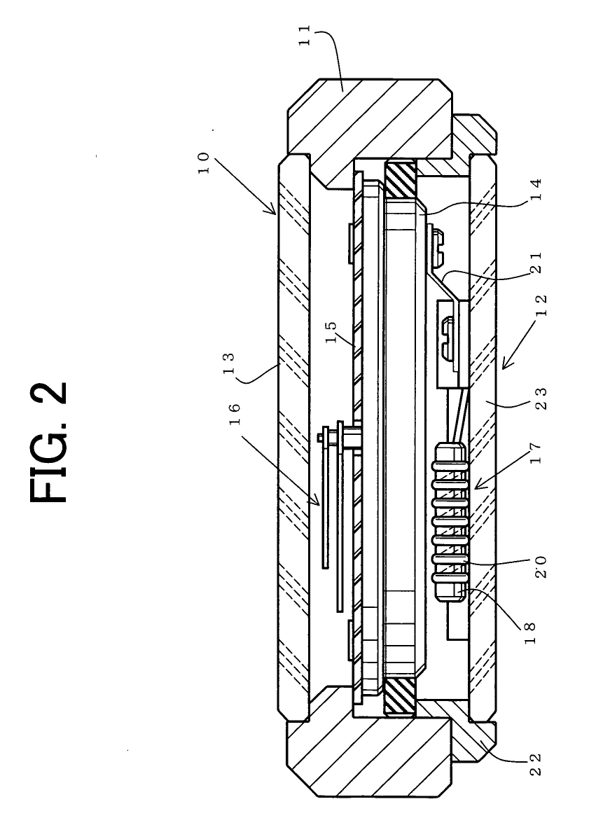

### BEST MODE FOR EMBODYING THE INVENTION

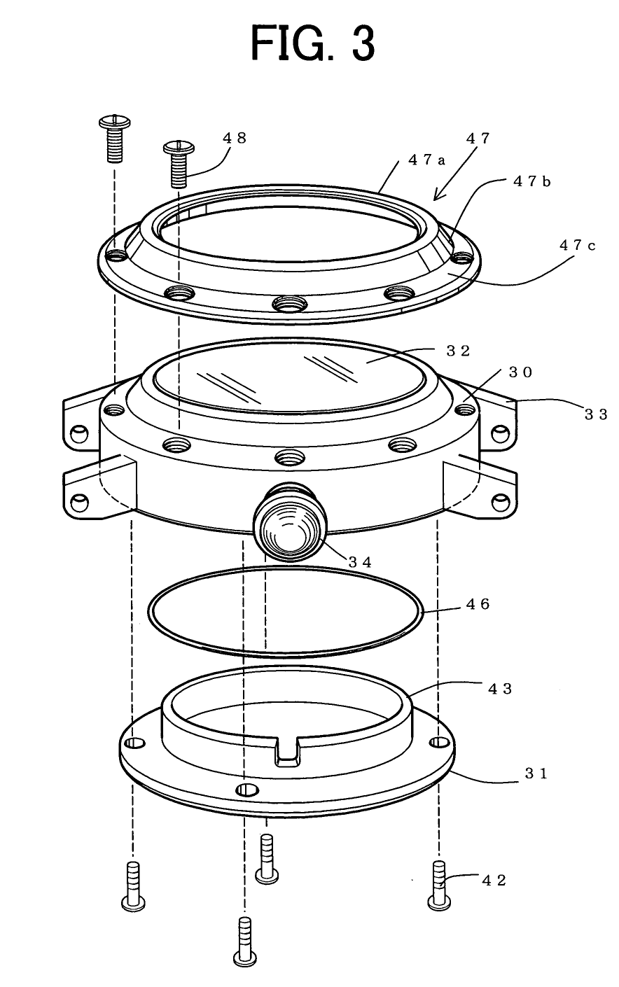

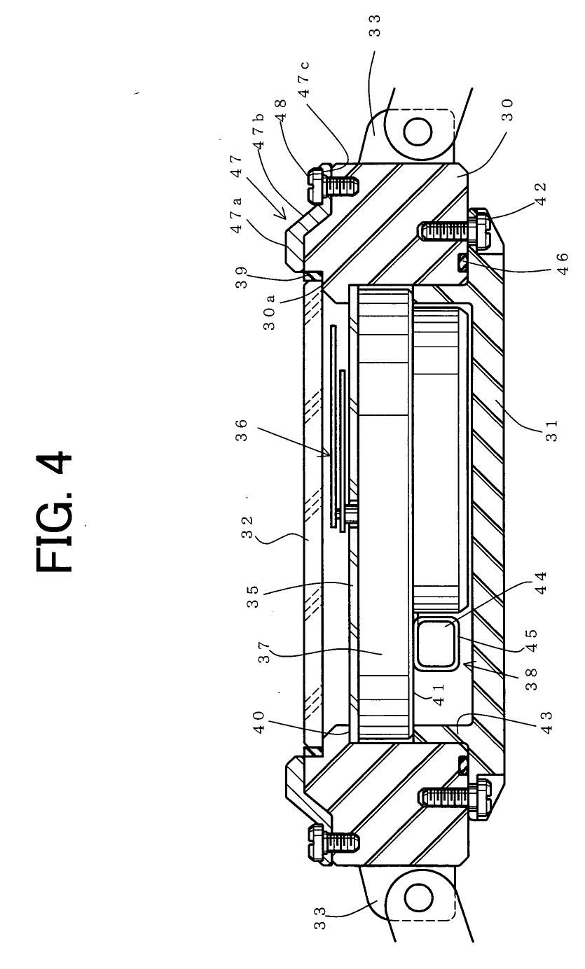

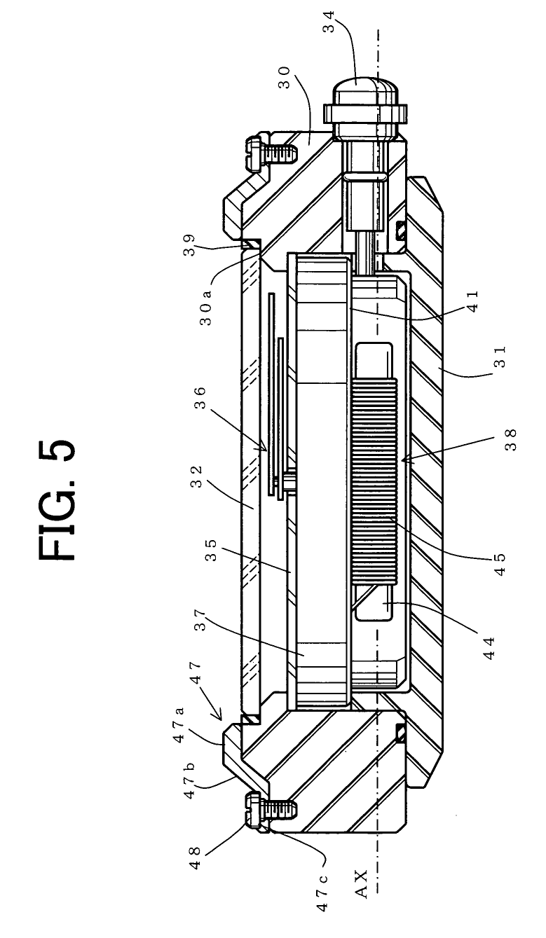

FIG. 3 is an exploded perspective view of a first embodiment according to the present invention, FIG. 4 is a sectional view of the watch taken along twelve to six o'clock axis, and FIG. 5 is a sectional view taken along three to nine o'clock axis.

The watchcase 10 as a case comprises a middle 30, back 31 and a shield 32. The middle 30 and the back 31 are made of an electrically nonconductive material such as synthetic resin, rubber and ceramics, and the shield 32, which is made of nonconductive glass, is secured to a stepped portion 30a through a seal 39.

As shown in FIGS. 4 and 5, the middle 30 is cylindrical, and as in an ordinary watch, a pair of band connecting legs 33 and a crown 34 protrudes from the ends thereof. The case contains a dial 35 as a time display, hands 36, movement 37, and a bar antenna 38. The dial 35, which is made of a nonconductive material such as synthetic resin and ceramics, is inserted between a stepped portion 40 of the middle 30 and the upper surface of the movement 37. The movement 37 has a small-diameter lower portion thereby forming a large stepped portion 41. The back 31 has an annular projection 43 and is fixed to the middle through a seal 46 by a screw 42, rendering the annular projection 43 to push the stepped portion 41 of the movement 37 upward so that the movement and the dial forcefully securely abut against the stepped portion 40 of the middle 30.

The bar antenna 38 comprises a core 44 and a coil 45 wound around the core and is disposed under the large stepped portion 41 in parallel to the crown 34. Thus the bar antenna is disposed in a lower portion of the case.

In order to contain the movement 37, dial 35, hands 36 and the shield 32, the middle 30 has a large thickness in the axial direction of the watch.

In accordance with the present invention, an annular exterior member 47 is securely mounted on the upper surface of the middle by a plurality of screws 48. The exterior member 47 is made of thin conductive material such as stainless steel, brass, titanium and titanium alloy, and comprises an upper flat surface 47a, inclined surface 47b, and a lower flat surface 47c. The screws 48 fix the exterior member at the lower flat surface. The exterior member 47 is not disposed within the horizon plane including an axis AX of the bar antenna 38 nor on the extension line of the axis AX.

As described above, the conductive metal exterior member 47 is thin and is provided on the upper surface of only a part of the middle. A large portion of the case is made of nonconductive material and the bar antenna 38 is disposed at the most remote location from the exterior member 47, and moreover, since the exterior member does not exist in the horizontal plane including the axis AX of the bar antenna and on the extension line thereof, the radio disturbance is minimized and time can be reliably corrected.

The time may be digitally indicated by a liquid crystal display. Additionally, the exterior member referred here is not a coating such as paint and plated film, but an independent member separated from the case.

In the present embodiment, each member is attached to each other by a metal screw having conductivity. However, if screws made of rigid synthetic resin or if adhesive is used, the radio disturbance can be further prevented.

In the first embodiment, the entire outer surfaces of the middle 30 and the back 31 composing the case are coated with paint including metallic pigment, thereby forming an ornament layer assuming stainless steel color having a metallic look.

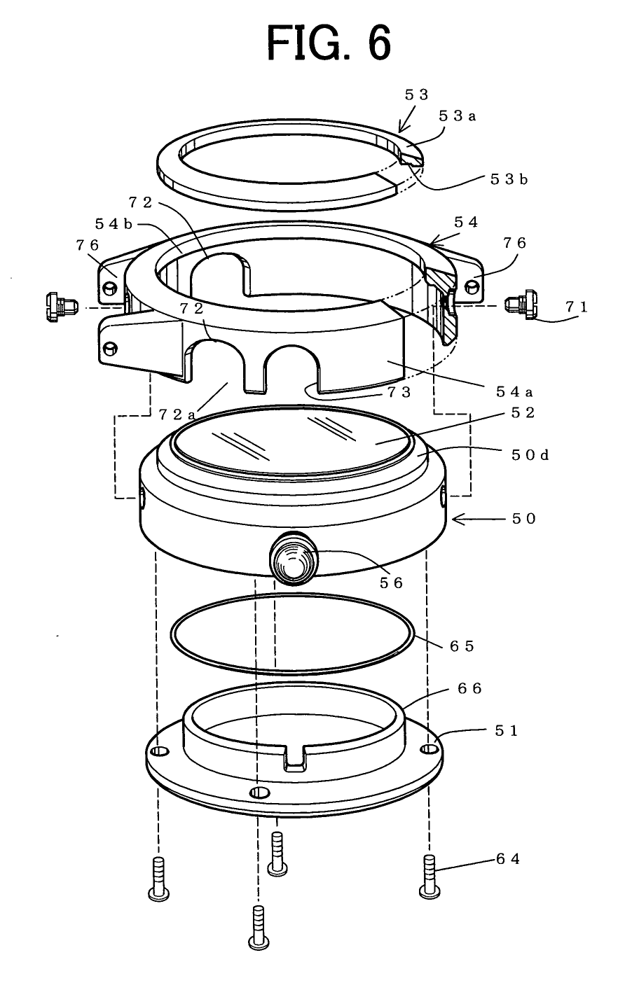

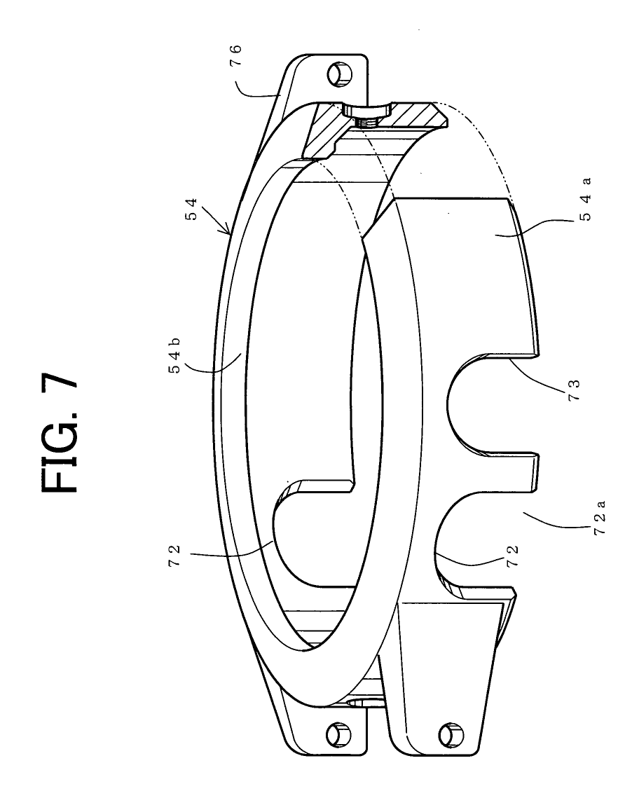

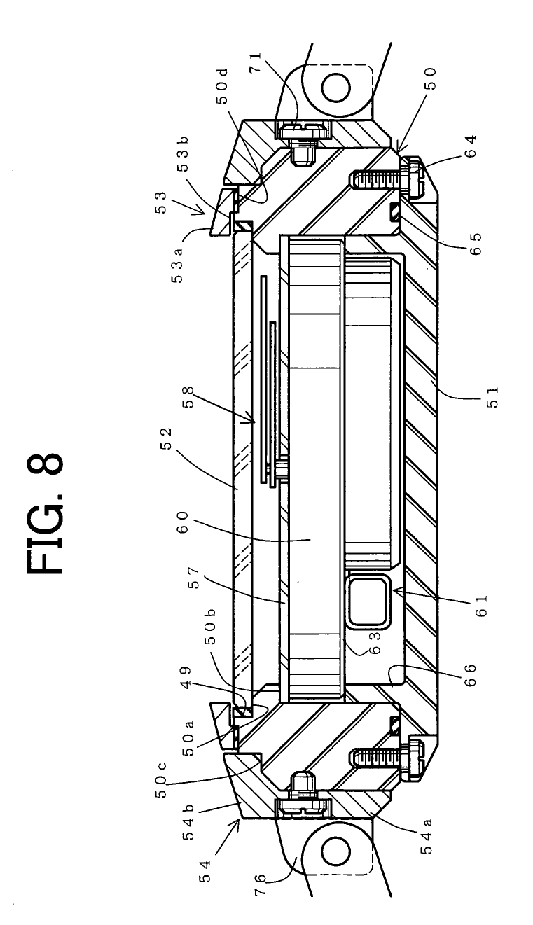

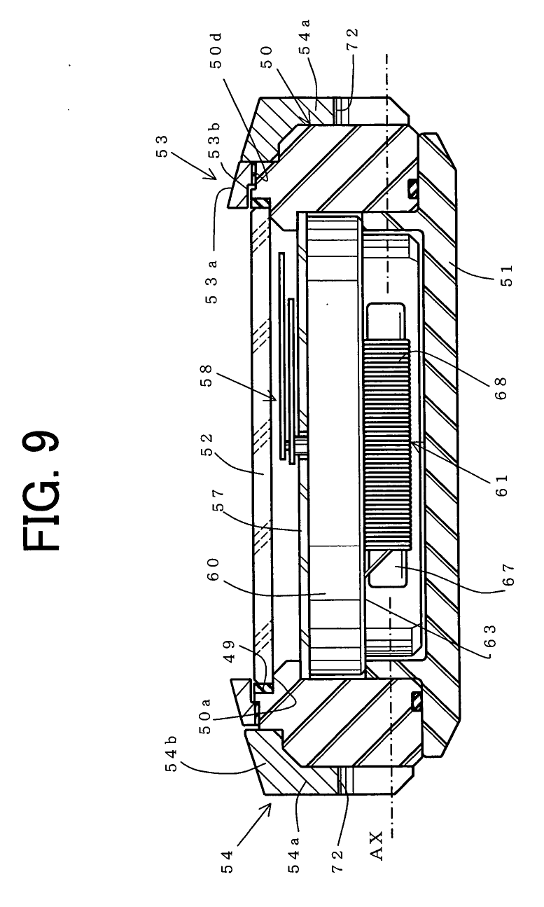

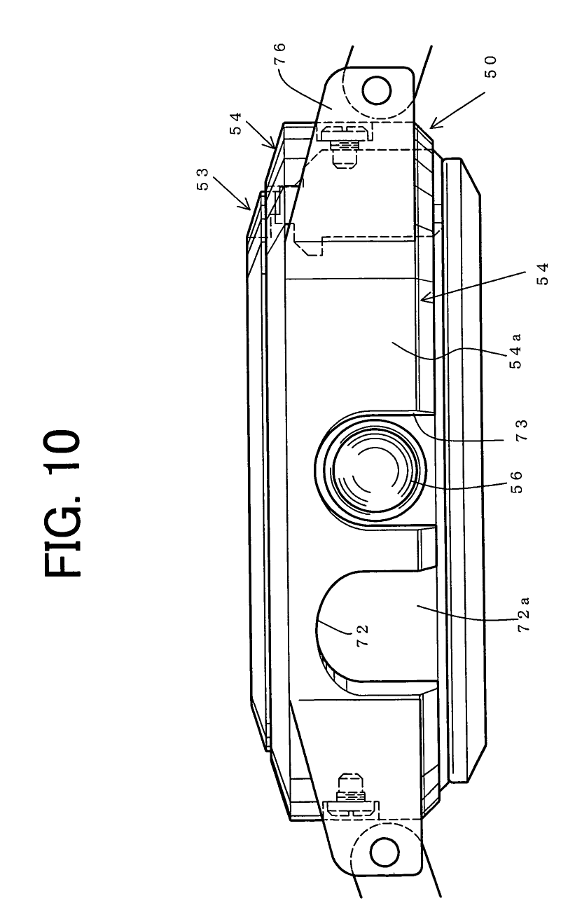

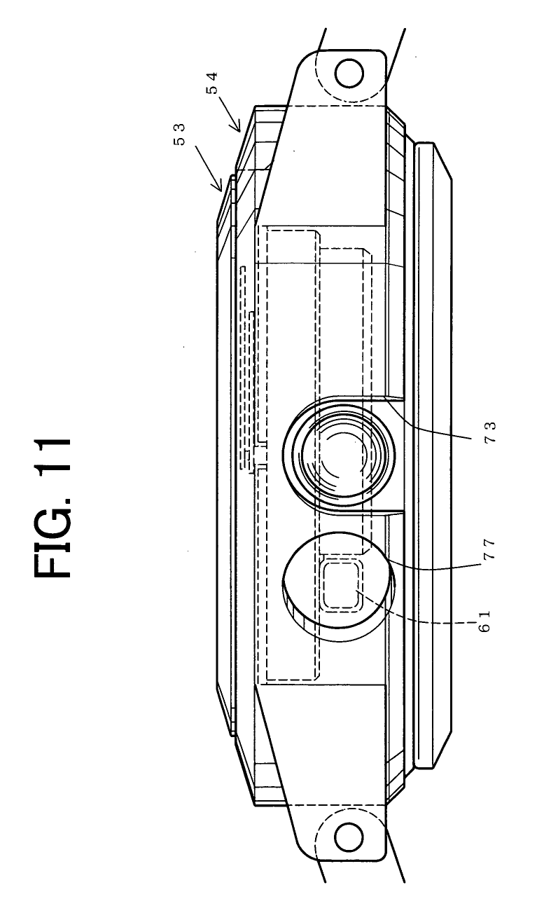

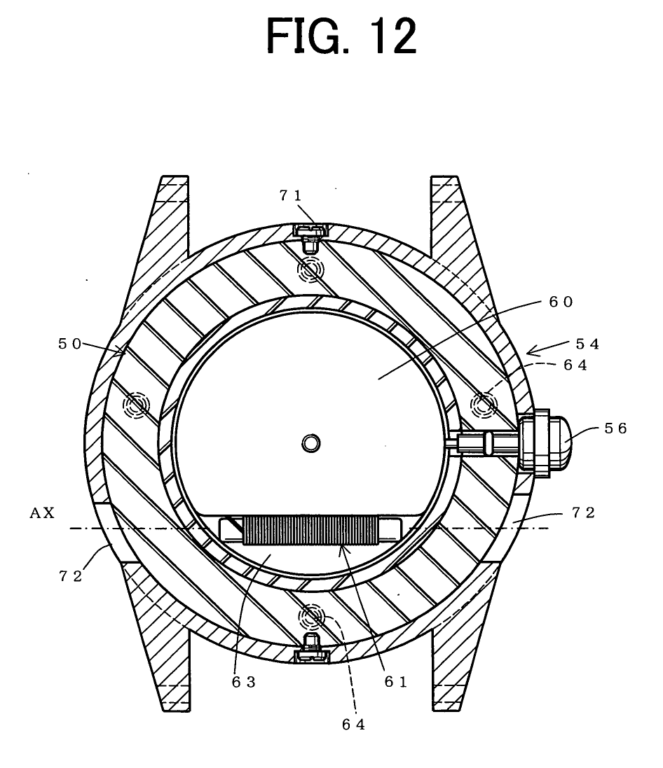

FIG. 6 is an exploded perspective view of a watch according to a second embodiment of the present invention, FIG. 7 is a perspective view showing a second exterior member, FIG. 8 is a sectional view showing the watch along twelve to six o'clock axis, FIG. 9 is a sectional view showing the watch along three to nine o'clock axis, FIG. 10 is a side view of the watch, FIG. 11 is a side view of an example of the watch, and FIG. 12 is a sectional plan view taken along the axis of a crown.

The watch according to the present embodiment is characterized in that the watch has, in addition to a middle 50, back 51 and a shield 52, two sets of exterior members, namely, a first exterior member 53 and a second exterior member 54 of conductive material.

The middle 50 and the back 51 are made of electrically nonconductive material such as synthetic resin, rubber and ceramics, and the shield 52, which is made of nonconductive glass, is securely attached to a stepped portion 50a of the middle through a seal 49.

As shown in FIG. 6, the middle 50 is cylindrical and has a projecting crown 56. In the case, there are provided a dial 57, hands 58, movement 60, and a bar antenna 61 as shown in FIGS. 8 and 9. The dial 57 is made of a nonconductive member such as a synthetic resin and ceramics. The movement 60 has a small-diameter lower portion thereby forming a large stepped portion 63. The back 51 has an annular projection 66 and is fixed to the middle through a seal 65 by a screw 64, rendering the annular projection 66 to push the stepped portion 63 of the movement 60 upward so that the movement and the dial forcefully securely abut against a stepped portion 50b of the middle 50.

The bar antenna 61 comprises a core 67 and a coil 68 wound around the core and, as shown in FIG. 12, is disposed under the large stepped portion 63 of the movement 60 in parallel to the crown 56, that is at a lower position in the lower portion of case.

The first and second exterior members 53 and 54 are made of thin conductive material such as stainless steel, brass, titanium and titanium alloy.

Referring to FIGS. 6 and 7, the first exterior member 53 having an annular disc shape comprises a slant 53a inclined downward toward the outer periphery on the upper surface thereof, and a stepped portion 53b on the underside thereof, and is attached to a flat portion 50d of the annular projection on the upper surface of the middle 50.

On the other hand, the second exterior member 54 is cylindrical and comprises a side cover 54a for covering the side periphery of the middle, and an engaging portion 54b protruding inward at the upper portion. The upper surface of the engaging portion 54b has the same inclination as the slant 53a of the first exterior member 53 so that the appearance becomes shapely. As shown in FIGS. 6 and 8, the second exterior member is provided with a pair of band connecting legs 76 at both ends thereof. The side cover 54a is securely attached to the side periphery of the middle 50 by screws 71. The side cover 54a is further provided with an opening 73 through which the crown 56 is projected. The engaging portion 54b is forcibly engaged with a stepped portion 50c of the middle 50.

In accordance with the present invention, the side cover 54a has a pair of escape openings 72. Each opening 72 has a cut out portion 72a formed by cutting out the lower edge of the second exterior member 54. As shown in FIGS. 9 and 12, the opening 72 is formed on the extension line of the axis AX of the bar antenna 61 as an axis thereof. Since the thickness of the side cover 54a in the radial direction is small and the thickness of the middle 50 is large, the side cover 54a is positioned largely distant from the bar antenna 61.

Thus, there is only the nonconductive middle and no metal member on the extension line of the axis AX of the bar antenna 61, so that although the middle is large in thickness, and in particular, the side cover 54a of the second exterior member 54 largely covers the periphery of the middle 50, the radio disturbance is extremely restrained.

Each opening 72 has the cut out portion 72a so that the cut out portion prevents the annular electric current from being generated around the opening 72 in the second exterior member 54.

If the case where an opening 77 in the shape of a closed circle is formed as shown in FIG. 11, an electric current induced around the opening 77 forms a current ring, which largely disturbs the reception, thereby rendering the opening inappropriate.

Moreover, as shown in the figures, the first exterior member 53 and the second exterior member 54 are disposed on the middle 50 apart from each other. Since the exterior members 53 and 54 are thus insulated from each other so as not to be electrically conductive, an annular current crossing over the exterior members 53 and 54 is not generated. Thus the favorable reception by the antenna is further maintained.

In the second embodiment, a stainless steel film is formed as an ornament layer on the entire outer surfaces of the middle 50 and the back 51 by dry plating. The exterior members 53 and 54 made of brass are mounted on the middle 50. Thus, only the exterior members 53 and 54 assume the gold color and the rest assumes the color of stainless steel having a metallic look.

A third embodiment will be described hereinafter.

The ornament layer formed by dry plating in the radio controlled watch of the second embodiment is displaced by an ornament layer formed by wet plating in the third embodiment. Thus, the same references numerals as those of the second embodiment designate the same parts in the third embodiment except for the ornament layer.

In the present embodiment, masking ink is applied on a predetermined area between a pair of connecting legs 76. Thereafter, a palladium coating as an ornament layer is formed on the outer surface of the middle 50 by wet plating. Thus the ornament layer comprising a palladium coating film having the stainless steel color is formed on the outer surface of the middle 50. The masking ink is then removed from the middle 50 thereby to expose the outer surface of the middle 50. Therefore, the exposed part of the outer surface of the middle 50 is formed as a slit.

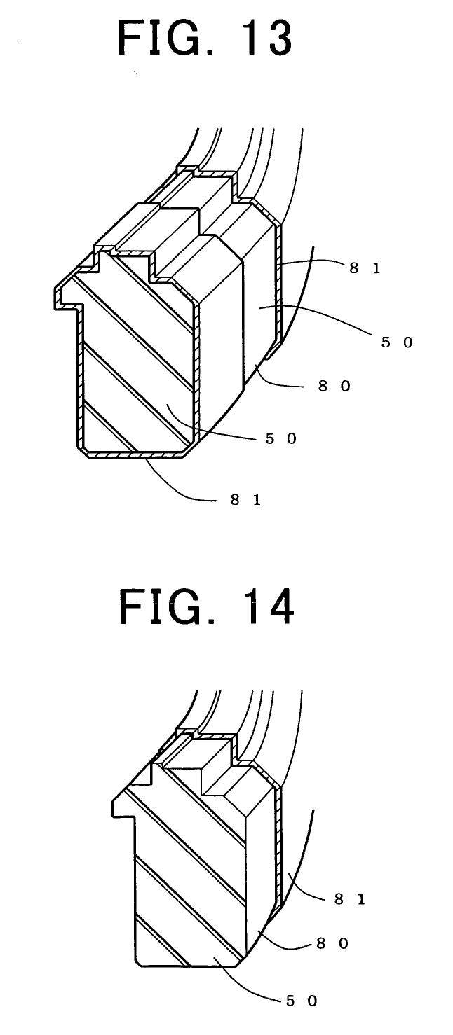

FIG. 13 shows a section of the middle 50 in the longitudinal direction and FIG. 14 shows a section in the longitudinal direction of a portion where the slit is formed. Referring to FIGS. 13 and 14, a slit 80 is formed as an annular zone of a predetermined width along the upper surface, outer periphery, underside surface and the inner periphery of the middle 50. The slit thus splits an ornament layer 81 covering the annular middle 50 so as not to form an annular conductive layer. Hence an annular electric current, which generates an interfering magnetic field causing a deterioration of reception ability, is prevented from being induced in the ornament layer so that good reception ability is maintained.

On the exterior member 53 composed of an austenitic stainless steel, which has a low magnetism, an ornament layer of gold-titanium alloy film is formed by dry plating, and then the exterior member is mounted on the middle 50. The exterior member 54, which is also made of an austenitic stainless steel, is mounted on the middle 50 without forming an ornament layer thereon. Thus the radio controlled watch has gold color only at the exterior member 53 and the rest has stainless steel color having a metallic look.

The slit 80 of the middle 50 is covered by the exterior member 54 provided to cover the middle 50 and hence not noticed. Moreover, when the band is connected to the band connecting legs 76, the slit is further covered by the band. Thus the slit does not deteriorate the appearance of the radio controlled watch. Thus, it is preferable to form the slit at a portion unlikely to be noticed.

In the present embodiment, the slit is formed by removing the masking ink. However, the masking ink may be kept on, thereby to form the slit.

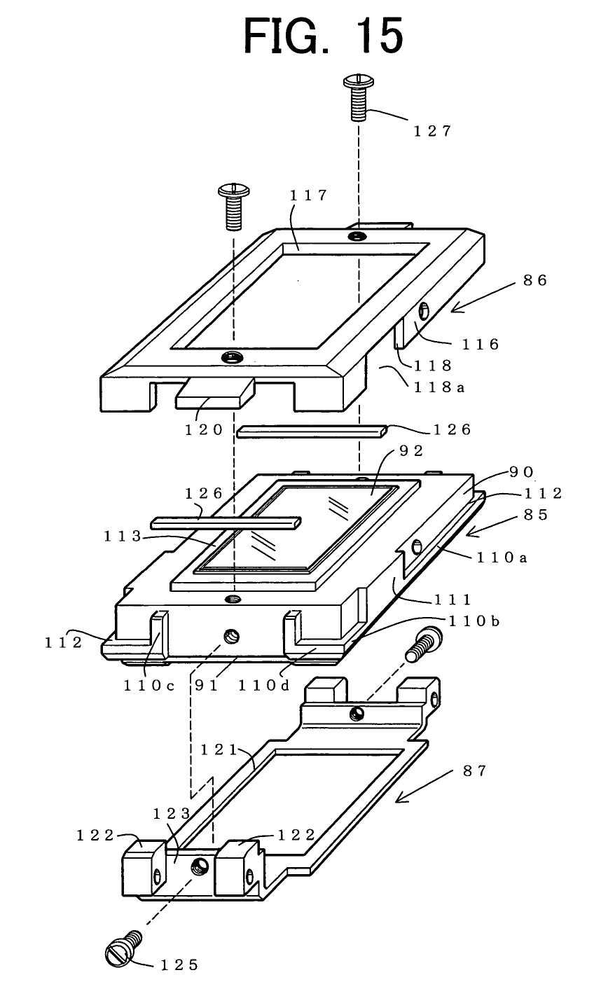

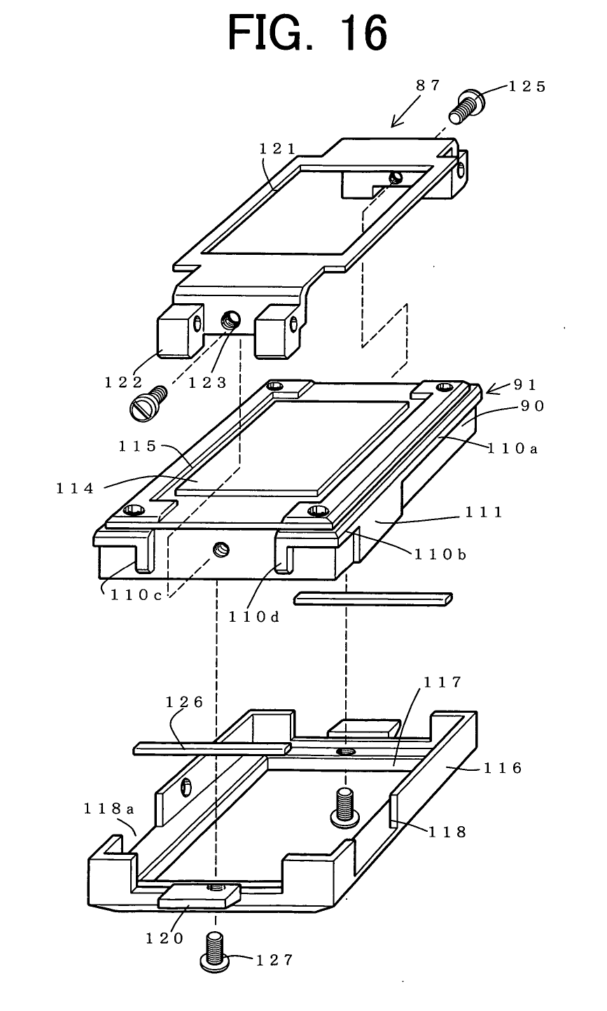

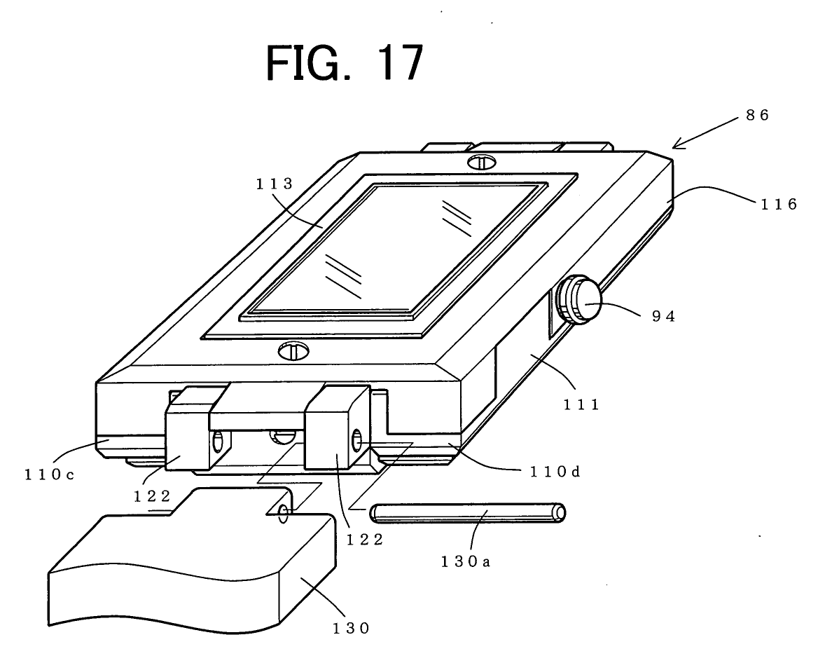

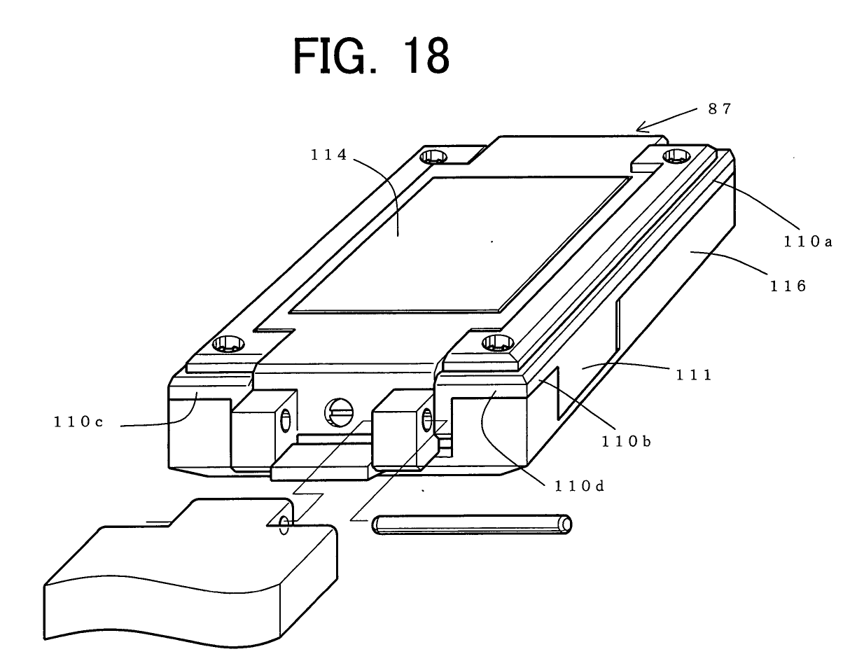

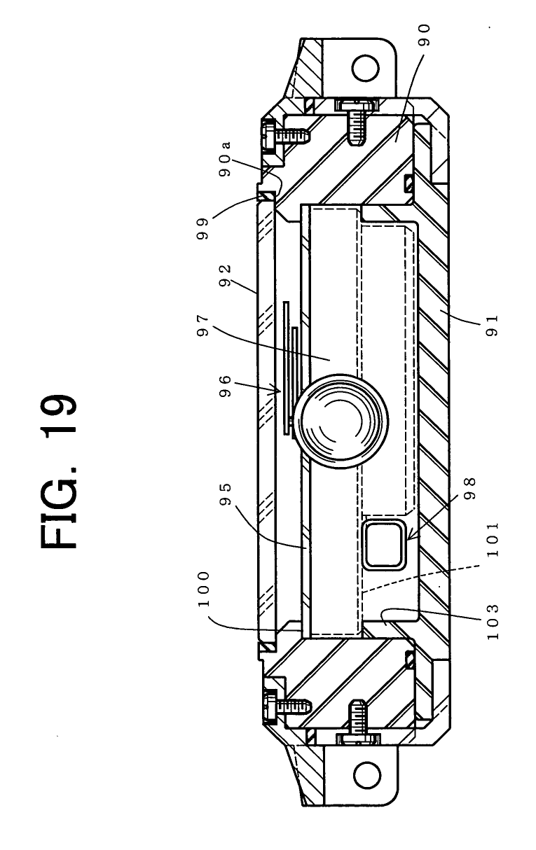

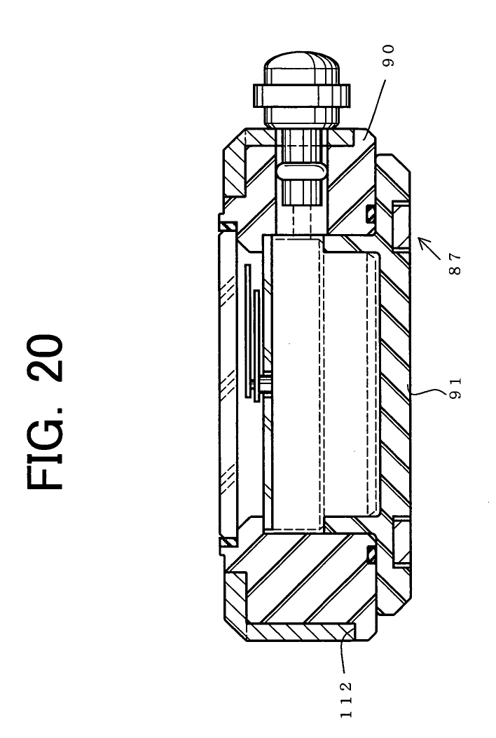

FIG. 15 is an exploded perspective view of a fourth embodiment as seen from above, FIG. 16 is an exploded perspective view as seen from below, FIG. 17 is a perspective view as seen from above, FIG. 18 is a perspective view as seen from below, FIG. 19 is a sectional view of a watch taken along twelve to six o'clock axis, and FIG. 20 is a sectional view taken along three to nine o'clock axis.

The watch has a watchcase 85 as a case, upper exterior member 86 attached to the upper portion of the case and a lower exterior member 87 attached to the lower portion thereof. The case 85 comprises a middle 90, back 91 and a shield 92. The middle 90 and the back 91 are made of nonconductive material such as synthetic resin, rubber and ceramics and the shield 92 is made of a nonconductive material such as glass and synthetic resin, and as shown in FIG. 19, is securely mounted on a stepped portion 90a of the middle 90 through a seal 99 by force fitting.

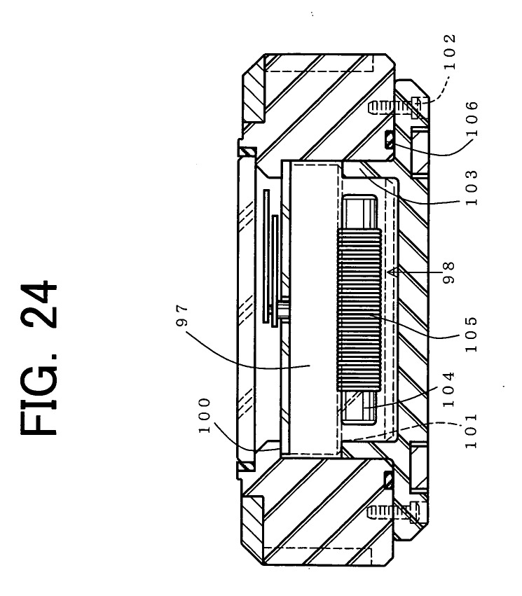

The middle 90 is a square prism in shape, rectangular in plan view, and as shown in FIG. 17, has a crown 94 protruding from one of the long sides thereof. As shown in FIGS. 19 and 20, a dial 95 as a time display, hands 96, movement 97 and a bar antenna 98 are housed in the case. The dial 95 is made of a nonconductive material such as synthetic resin, ceramics and glass, and is inserted between a stepped portion 100 and the upper surface of the movement 97. The movement 97 has a small lower portion, thereby forming a large stepped portion 101. The back 91 has an annular projection 103 at the inner side and is secured to the middle through a seal 106 by screws 102 (FIG. 24), rendering the upper surface of the annular projection 103 to push the stepped portion 101 of the movement 97 upward so that the movement and the dial forcefully securely abut against a stepped portion 100 of the middle 90 (FIGS. 20, 24).

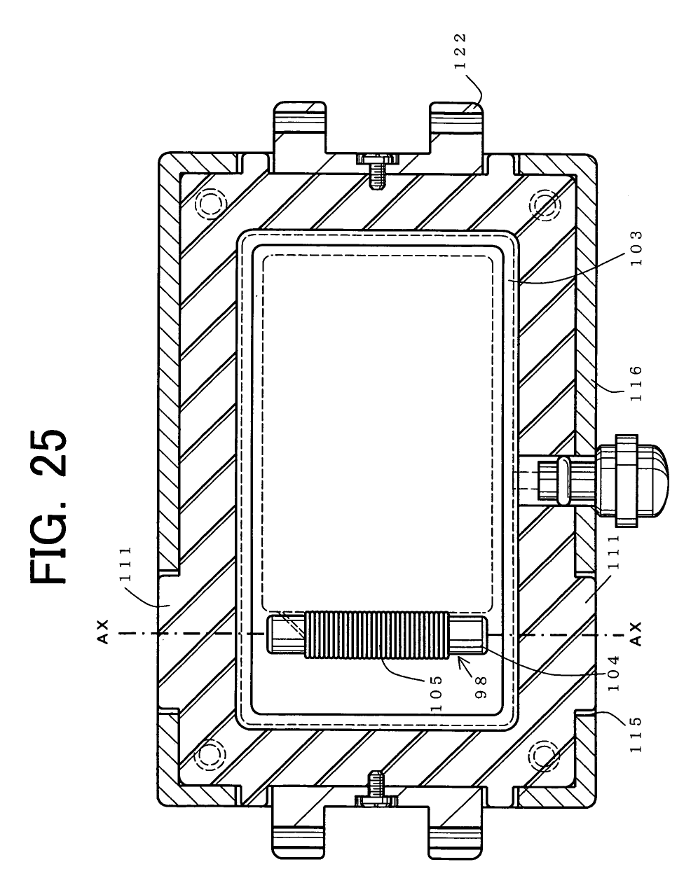

The bar antenna 98 comprises a magnetic core 104 and a coil 105 wound around the magnetic core, and as shown in FIG. 25, is disposed under the large stepped portion 101 (FIG. 19) in parallel to the short side of the middle 90. Namely, the bar antenna is disposed in the lower portion of the case.

In order to contain the movement 97, dial 95, hands and the shield 92, the middle 90 has a large thickness in the axial direction of the watch.

As shown in FIGS. 15 and 16, ridges 110a and 110b and an inserting portion 111 are formed on each of the opposite long sides of the middle 90 on a lower outer wall thereof. The inserting portion 111 is formed in continuity with the ridges 110a and 110b. On the lower outer wall of the middle 90 at each of the opposite short sides, L-shaped ridges 110c and 110d are symmetrically projected. Each of the ridges 110a, 110b, 110c, and 110d is continuously formed on the outer wall of the middle 90, thereby forming stepped portions 112 on the ridges 110a, 110b, 110c and 110d. Each of the outer surfaces of the ridges and the inserting portion is positioned at the same height. As shown in FIG. 25, the inserting portions 111 oppose each other along the axis AX of the bar antenna 98 so that the thickness of the middle is large at these portions. On the upper surface of the middle 90, a rectangular annular projecting inserting portion 113 is formed for an upper exterior member 86 which will later be described.

As shown in FIG. 16, on the underside of the back 91, a rectangular projecting inserting portion 114 for the lower exterior member 87 is formed, so that a recess 115 is formed around the inserting portion.

On the other hand, as shown in FIGS. 15 and 16, upper exterior member 86 comprises an outer peripheral wall 116, upper opening 117 and a side opening 118 in which the inserting portion 111 of the middle is inserted. Namely, the inserting portion 111 and the opening 118 are substantially the same in shape. In addition, a projection 120 projects from the upper portion of each short side of the upper exterior member. The lower side of the side opening 118 is cut away to form a recess 118a, which prevents an annular electric current from being formed around the opening so that a deterioration of the reception ability is prevented.

The lower exterior member 87 further has a bottom opening 121, a supporting plate 123 extending from each of the short sides of the exterior member, and a pair of connecting legs 122 projecting from the supporting plates.

The assembling of the whole watch is described hereinafter. Referring to FIG. 15, the supporting plates 123 are engaged with the middle 90 at the short sides thereof, and as shown in FIG. 17, the connecting legs 122 are inserted in a space between the L-shaped ridges 110c and 110d. The inserting portion 114 of the back 91 is engaged with the opening 121 so that the frame around the opening is inserted in the recess 115. The lower exterior member 87 is then securely mounted on the middle 90 by screws 125.

Thereafter, as one of insulating portions, insulating members 126 each of which is a nonconductive rod are formed independent from the middle 90 and mounted on the L-shaped ridges 110c and 110d. Although the same material as that of the case may be used as the material of the insulating member 126, it is preferable to use a flexible synthetic resin. The upper exterior member 86 is mounted on the middle 90 interposing the insulating members 126. Hence the inserting portion 113 on the upper surface of the middle 90 is inserted in the opening 117 and the inserting portions 111 are inserted in the openings 118. The projections 120 are also inserted between respective pairs of connecting legs 122.

Thereafter, the assemblage is completed by fixing the upper exterior member 86 to the middle with screws 127. Referring to FIG. 17, a band 130 is connected to the connecting legs 122 by a pin 130a.

As shown in the figures, the upper and lower exterior members 86 and 87 are mounted on the case 85 with a space there-between, thereby not to be in contact with each other.

More particularly, since the insulating ridges 110a, 110b, 110c and 110d are disposed in the space between the upper and lower exterior members 86 and 87, although an external force is applied to one of the exterior members so that the exterior members become close to each other, the contact between the upper and lower members 86 and 87 is prevented without fail. Likewise, since the insulating members 126 are disposed between the upper and lower exterior members 86 and 87, the contact between the upper and lower exterior members is prevented without fail.

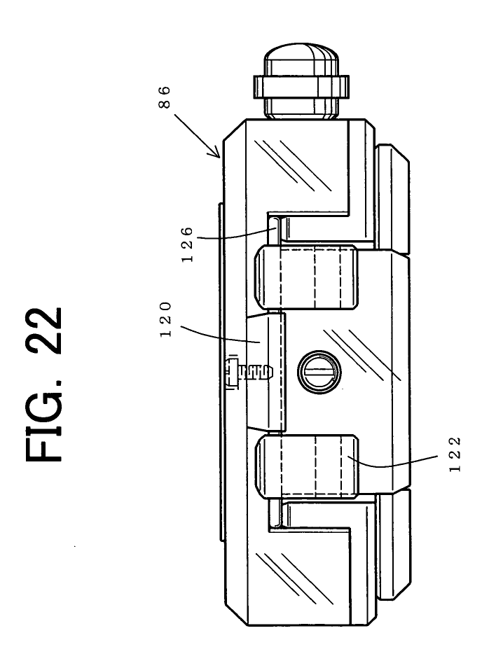

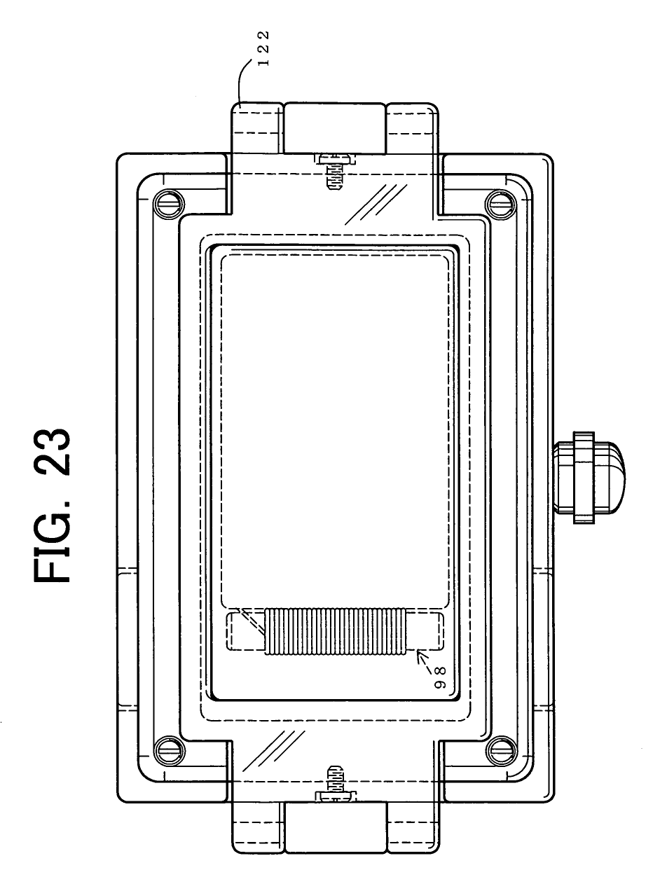

As shown in FIG. 22, the projections 120 are not in contact with the connecting legs 122. The L-shaped ridges 110c and 110d prevent the projections 120 and the connecting legs 122 from approaching one another in the horizontal direction, or in FIG. 22, right and left directions. More particularly, the vertically extending portions in FIG. 22 of the L-shaped ridges 110c and 110d prevent the projections 120 and the connecting legs 122 from being in contact with one another without fail.

Since the upper and lower exterior members 86 and 87 are mounted on the case 85 with a space there-between, the insulation between the members is ensured. Thus, annular current about the antenna is prevented, thereby preventing the reception ability of the antenna to decrease.

In the thus assembled state, the outer walls of the inserting portions 111 and ridges 110a to 110d are flush with the outer wall of the upper exterior member 86, continual on the same plane without any gaps. The underside of the lower exterior member 87 is also flush with the underside of the back 91. Accordingly, the skin of the user is not injured when the watch is worn. Moreover, the appearance of the radio controlled watch is improved, thereby increasing the merits of the watch as personal adornments and accessories.

As shown in the figures, parts of the case 85 of synthetic resin are exposed and seen through the spaces between the metal exterior members 86 and 87. The smaller the exposed area of the case becomes, and hence the larger the area of the metal exterior members, the more effective the metallic look of the appearance of the radio controlled watch becomes. Hence it is preferable to form the outer areas of the exterior members 86 and 87 covering the case 85 larger than the exposed area of the case 85.

In addition, each insulating member 126 which is disposed under the projection 120 is concealed by the projection 120 which extends out of the exterior member. The insulating member 126 is disposed between the corresponding pair of connecting legs 122 and oppose the band 130 so as to be concealed by the band 130. The insulating member 126 is thus less likely to be noted so that the appearance of the radio controlled watch is improved. Each insulating member 126 is further protected by the projection 120 and the band 130 so that external force compelling the insulating member 126 to be removed from the case is not exerted. Thus the insulating members 126 are securely mounted on the case.

Furthermore, although screws are employed as securing means for attaching the external members 86 and 87 to the middle 90, the securing means is not limited to the screws and therefore, various securing means such as by force fit and adhesive may be used.

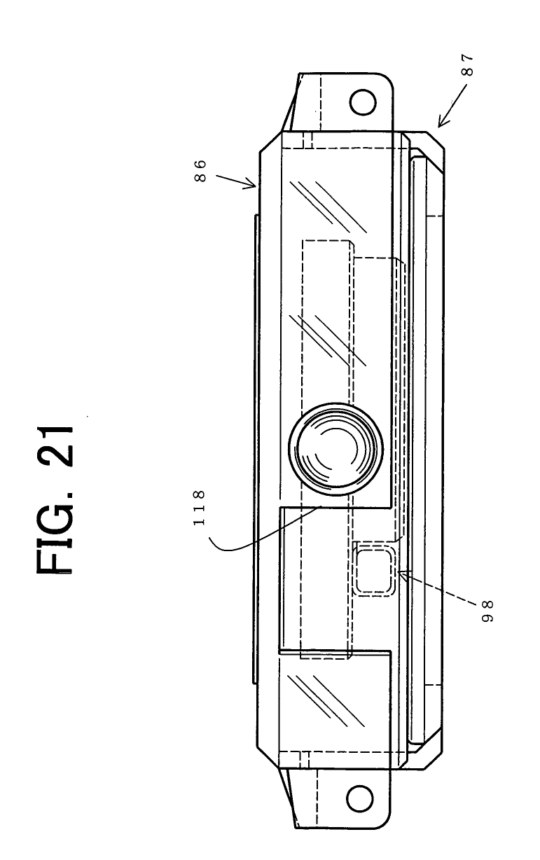

As shown in FIGS. 21 and 25, the upper and lower exterior members 86 and 87 do not exist on the extension line of the axis AX of the core 104 of the antenna 98. In order to realize such an arrangement, the openings 118 are formed in the upper exterior member 86 on the opposite extensions of the axis AX in the illustrated example. However, the openings may be formed in the lower exterior member.

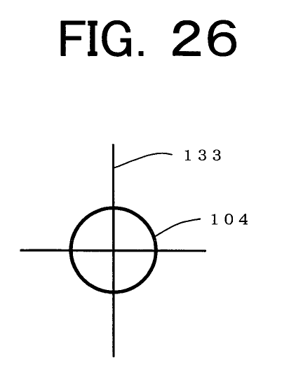

The openings 117 and 121 are formed in the exterior members so that, the exterior members are not disposed in a projection plane when the bar antenna is projected by light rays in a direction of a line 133 (FIG. 26) perpendicular to the horizontal plane passing through the axis of the core 104. In the illustrated example, although the openings 117 and 121 are disposed perpendicular to the vertical plane 133 passing through the axis of the antenna, the openings may be formed in the exterior members along a plane besides the vertical plane passing through the axis AX. Moreover, the axis projecting openings may be formed in the exterior members in a plurality of planes passing through the axis AX in numbers larger than that shown in the figure.

Even though conductive exterior members are employed, the deterioration of reception ability caused by electric current induced by the exterior members is prevented in the above described construction.

In addition, since the upper and lower exterior members 86 and 87 are disposed in the case 85 apart from each other, and moreover, by interposing insulating members, more particularly, the ridges 110a, 110b, 110c, and 110d and the insulating members 126, the short-circuiting between the exterior members 86 and 87 are avoided without fail, thereby preventing a substantial deterioration in radio reception caused by annular current.

In the illustrated example, although two exterior members 86 and 87 are shown so as to surround the antenna 98, three or more exterior members may be disposed surrounding the antenna 98. In such a case, at least two of three exterior members are likewise insulated from each other so that the exterior members are not annually electrically conductive about the antenna 98. Hence the reception ability is not deteriorated.

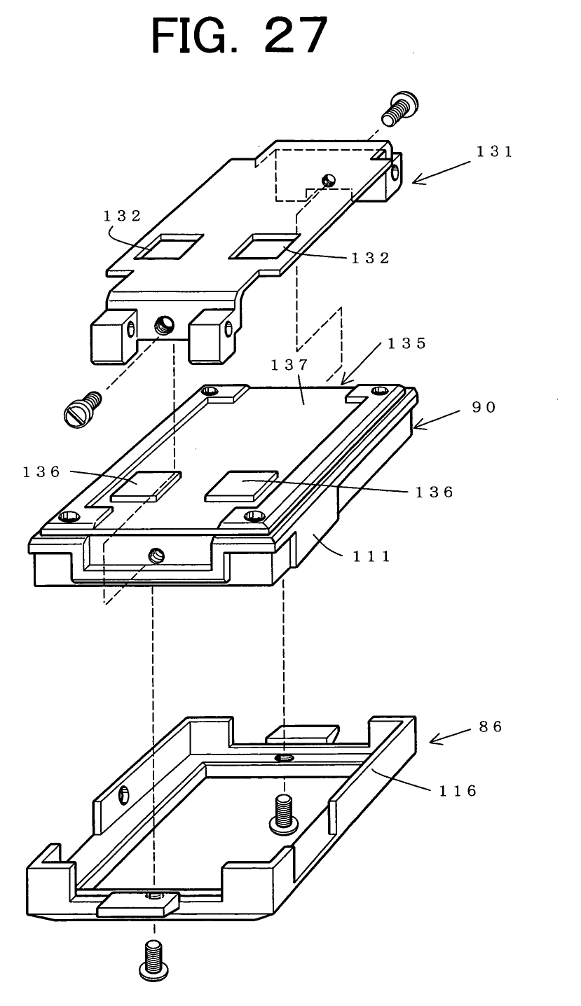

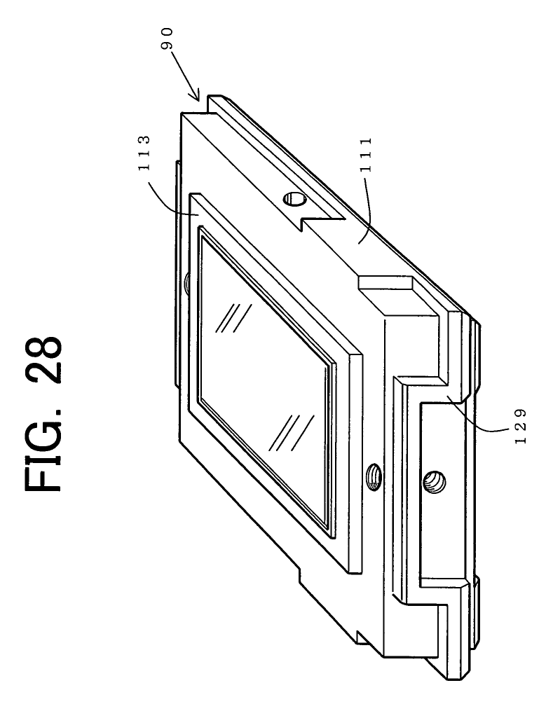

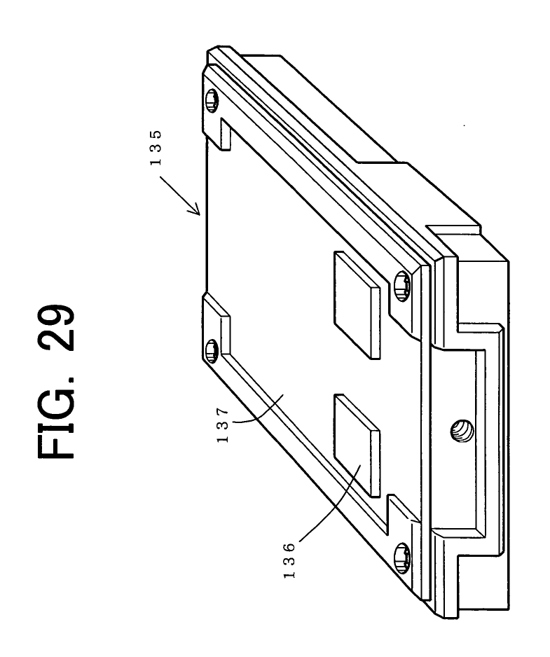

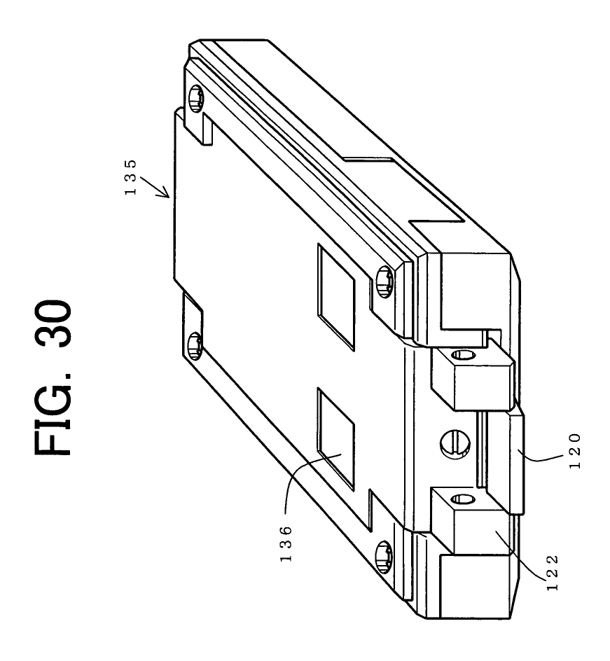

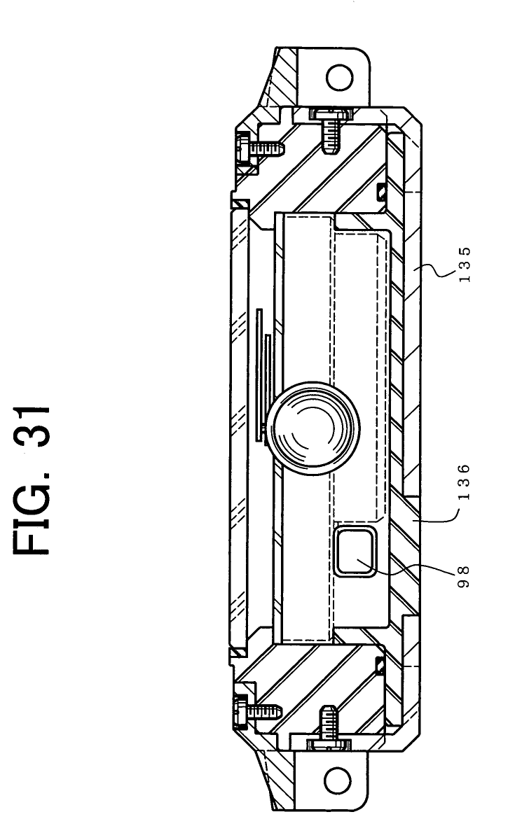

FIG. 27 is a perspective view of a fifth embodiment of the present invention, FIG. 28 is a perspective view showing an upper portion of a case, FIG. 29 is a perspective view showing a lower portion of the case, and FIG. 30 is a perspective view showing a lower portion of an assembled watch.

In the fourth embodiment described above, the opening 121 has a large area with respect to the case. The fifth embodiment is an achievement resulting from experiments regarding the minimum area of the opening.

Only the portions that differ from those of the fourth embodiment are explained hereinafter, and the same parts as those of the fourth embodiment are designated by the same references and the descriptions thereof are hence omitted.

The L-shaped ridges 110c and 110d in the fourth embodiment are combined together to form an insulating projection 129 as shown in FIG. 28, so that the insulating members 126 are obviated.

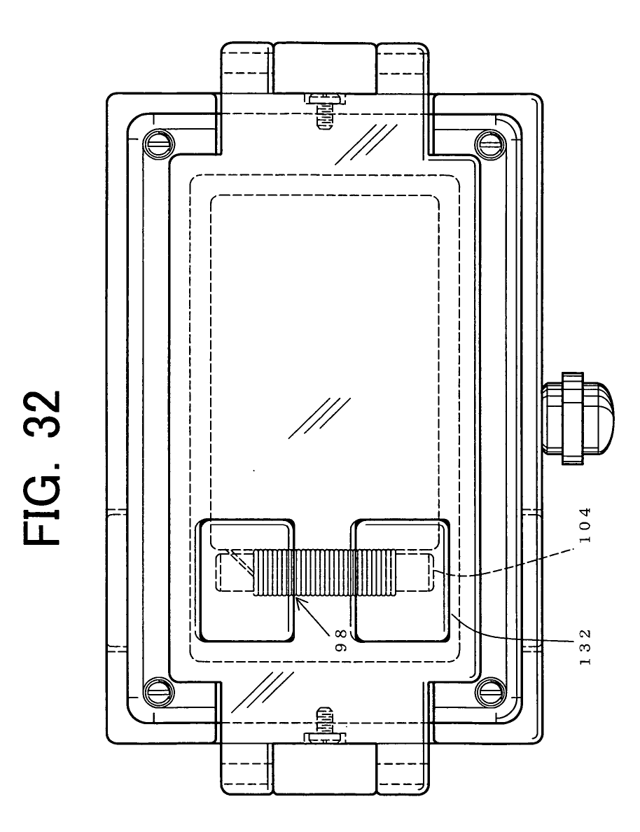

Referring to FIG. 27, a pair of openings 132 are formed in a lower exterior member 131. As shown in FIG. 32, the openings 132 are formed at least at locations including areas where the exposed portions of the core 104 of the bar antenna 98 are downwardly projected. Namely, in order to maintain favorable reception, it is preferable to render the openings larger than the projection of the exposed portion of the core.

On the other hand, as shown in FIGS. 27 and 29, on the underside of a back 135, a pair of inserting portion 136 which are inserted in the openings 132, and a recess 137 wherein the lower exterior member 131 is inserted are formed.

Other configurations and constructions, and also assemblage are the same as in the first embodiment, and the explanations thereof are therefore omitted.

### PROBABILITY OF INDUSTRIAL EXPLOITATION

In accordance with the present invention, the case for containing the antenna is nonconductive while the exterior members covering the outer portion of the case is made of conductive material such as metal. Accordingly, the distance between the antenna and the conductive member is increased than in a watch with a conductive case so that radio disturbance is less liable to occur and hence a radio controlled watch an antenna of which is capable of favorable radio reception is provided.

The distance between the antenna and the conductive member is increased without enlarging the case so that a smaller case is realized than in a conventional watch.

In addition, since the exterior members are made of conductive material such as metal, the radio controlled watch assumes a metallic look. This enables the case to be recognized as being made of solid metal, thereby maintaining classiness and beautiful appearance.

The exterior member referred here is not a coating such as paint or plated film, but an individual member separate from the case.

Moreover, a plurality of exterior members may be provided to cover the upper surface, periphery and the underside of the case.

With such a construction, a radio controlled watch having a metallic look not only on the upper surface and the periphery of the case, but also on the underside is provided.

Thus, although a conductive exterior member of metal, for example, is used to give a metallic look, an insulating means prevents annular conduction to occur, so that the deterioration of the reception ability of the antenna is prevented, thereby maintaining the accuracy of the watch.

1. A radio controlled watch comprising a case made of a nonconductive material and containing an antenna and a watch movement, and an exterior member made of conductive material attached on an outer portion of the case.

2. The radio controlled watch according to claim 1 wherein the case has a large thickness in an axial direction of the watch compared with a thickness of the exterior member.

3. The radio controlled watch according to claim 1 wherein the antenna comprises a core and a coil wound around the core.

4. The radio controlled watch according to claim 1 or 3 wherein the case includes a middle.

5. The radio controlled watch according to claim 1 where in the exterior member comprises a plurality of members.

6. The radio controlled watch according to claim 1 or 3 wherein the exterior member covers an upper surface and a periphery of a middle of the case.

7. The radio controlled watch according to claim 3 wherein the exterior member is disposed in a plane other than a horizontal plane including an axis of the core.

8. The radio controlled watch according to claim 3 wherein the exterior member is disposed at a location other than on an extension line of an axis of the core.

9. The radio controlled watch according to claim 3 wherein the case comprises a plurality of parts at least two of which are secured to each other by a screw and the screw is disposed at a location other than on an extension line of an axis of the core.

10. The radio controlled watch according to claim 4 wherein the exterior member covers an upper surface of the middle.

11. The radio controlled watch according to claim 4 wherein the exterior member covers an outer surface of the middle.

12. The radio controlled watch according to claim 4 wherein the antenna is disposed in a lower portion of the middle.

13. The radio controlled watch according to claim 11 wherein the exterior member has an escape opening on an extension line of an axis of the core.

14. The radio controlled watch according to claim 11 wherein band connecting legs for connecting bands for putting on the watch on a body of a wearer are formed on the exterior member.

15. The radio controlled watch according to claim 13 wherein the escape opening is formed by cutting out an outer edge of the exterior member.

16. The radio controlled watch according to claim 13 wherein two opposite openings are formed on the extension line of the axis.

17. The radio controlled watch according to claim 1 wherein an ornament layer covers at least an exposed portion on an outer surface of the case uncovered by the exterior member.

18. The radio controlled watch according to claim 17 wherein the ornament layer is a metal layer which assumes a metallic appearance.

19. The radio controlled watch according to claim 17 wherein the ornament layer is at least one film selected from films formed by coating, wet plating and dry plating.

20. The radio controlled watch according to claim 1 wherein a plurality of exterior members cover an upper surface, periphery and a lower surface of the case.

21. The radio controlled watch according to claim 1 wherein the exterior member has an upper exterior member disposed on an upper surface of the case and a lower exterior member disposed on a lower portion of the case.

22. The radio controlled watch according to claim 13 wherein the escape opening is a projection opening which is formed at a projection plane formed by projection light rays in a direction perpendicular to the axis of the core of the antenna.

23. The radio controlled watch according to claim 22 wherein the projection opening has an area larger than an area of a projection of the antenna.

24. The radio controlled watch according to claim 22 wherein the projection opening opposes end portions of antenna.

25. The radio controlled watch according to claim 23 wherein the projection opening has an area larger than an are of a projection of exposed end portion exposed from the coil.

26. The radio controlled watch according to claim 13 further comprising an inserting portion formed in an antenna receiving portion and inserted in the escape opening.

27. The radio controlled watch according to claim 26 wherein an outer end surface of the inserting portion is substantially flush with the exterior member having the opening.

28. The radio controlled watch according to claim 20 wherein an upper exterior member has an outer periphery for covering the periphery of the case and an axial opening is formed in the outer periphery.

29. The radio controlled watch according to claim 28 wherein a ridge for receiving an underside of the exterior member is formed on a lower periphery of the case.

30. The radio controlled watch according to claim 29 wherein outer surfaces of an inserting portion and the ridge are substantially flush with the outer periphery of the upper exterior member.

31. The radio controlled watch according to any one of claims 22 to 25 wherein the projection opening is formed in a lower exterior member.

32. The radio controlled watch according to claim 20 wherein an projection opening has an area larger than an area of a projection of the antenna on an upper exterior member, and is formed in a lower exterior member opposite each ends of the antenna.

33. The radio controlled watch according to any one of claims 20 and 21 wherein the exterior member is inserted in a recess formed in the case.

34. The radio controlled watch according to any one of claims 20 and 21 wherein the exterior member engages a ridge projecting from the case.

35. A radio controlled watch comprising:
a case made of a nonconductive material and containing an antenna and a watch movement;
a plurality of conductive exterior members attached on the outer portion of the case; and
insulating means for insulating at least two of the exterior members which generates annular conduction when in contact with each other.

36. The radio controlled watch according to claim 35 wherein the plurality of exterior members are disposed to surround the antenna.

37. The radio controlled watch according to claim 36 wherein the insulating means insulate at least two of the exterior members so as to prevent an annular conduction surrounding the antenna.

38. The radio controlled watch according to claim 37 wherein the antenna is a bar antenna comprising a core and a coil wound around the core is provided, the insulating means is provided to insulate at least two of the exterior members so that the exterior members do not generate an annular conduction about an axis of the core.

39. The radio controlled watch according to any one of claims 35 to 38 wherein at least one opening is formed in at least one of the exterior members so that the antenna may receive radio transmission.

40. The radio controlled watch according to claim 39 wherein the opening in the exterior member is formed by cutting out an outer edge of the exterior member.

41. The radio controlled watch according to claim 40 wherein the bar antenna comprising a core and a coil wound around the core is provided, and the opening is an axial opening formed along an axis of the core.

42. The radio controlled watch according to claim 41 wherein the opening in the exterior member is formed by cutting out an outer edge of the exterior member.

43. The radio controlled watch according to any one of claims 35 to 41 wherein the insulating means is means for separating at least two of the exterior members.

44. The radio controlled watch according to claim 43 wherein the insulating means is a means for mounting at least two of the exterior members in the case with a space between the exterior members.

45. The radio controlled watch according to claim 43 wherein the insulating means includes a nonconductive insulating portion disposed between at least two of the exterior members.

46. The radio controlled watch according to claim 45 wherein the insulating portion is an insulating member independent from the case, and disposed between at least two of the exterior members.

47. The radio controlled watch according to claim 45 wherein the insulating portion includes an insulating projection formed on the case and disposed between at least two of the exterior members.

48. The radio controlled watch according to claim 45 wherein the insulating portion is disposed at a position opposite a band connected to the radio controlled watch.

49. The radio controlled watch according to claim 45 wherein the insulating portion is disposed between a pair of band connecting legs formed on the exterior member for putting on the watch on a body of a wearer.

50. The radio controlled watch according to claim 45 wherein the insulating portion is disposed under an outwardly extending projection.

51. The radio controlled watch according to any one of claims 35 to 50 wherein an exposed area of an outer surface of the case is smaller than an area of an outer surface of the exterior member.

52. The radio controlled watch according to any one of claims 35 to 50 wherein a plurality of exterior members cover an upper surface, periphery, and an underside of the case.

53. The radio controlled watch according to claim 52 wherein the exterior member has an upper exterior member disposed on the upper surface of the case and a lower exterior member disposed on the underside of the case.

54. The radio controlled watch according to claim 53 wherein a peripheral portion for covering the periphery of the case is provided in at least one of the upper and lower exterior members.

55. The radio controlled watch according to claim wherein the opening of the exterior member is formed in peripheral portion.
